(19) United States
(12) Patent Application Publication
(10) Pub. No.: US 2006/0254526 A1
(43) Pub. Date: Nov. 16, 2006

(54) Dog bed

(76) Inventor: Rich Andriola, Scottsdale, AZ (US)

Correspondence Address: BEESON SKINNER BEVERLY LLP, ONE KAISER PLAZA, SUITE 750, OAKLAND, CA, 94612, US

(21) Appl. No.: 11/434,985

(22) Filed: May 15, 2006

Related U.S. Application Data
(60) Provisional application No. 60/681,297, filed on May 16, 2005.

(51) Int. Cl. A01K 1/035

(52) U.S. Cl. 119/28.5

(57) ABSTRACT

A dog bed comprises a base pad, bolsters including back and side pads, a cover enveloping the base, back and side pads, and a securing system for holding the cover snugly around the pads. The back and side pads are disposed on a perimeter portion of the base pad. The securing system includes a plurality of straps including a lower strap attached to the cover at a lower attachment site adjacent a lower intersection formed by the inside face of one of the bolsters and the upper surface of the base pad, and which extends downwardly through an aperture from the upper to the lower surface of the base pad; an upper strap is attached to the cover at an upper attachment site adjacent an upper intersection formed by the intersection of the top and outside faces of the bolster. The upper and lower straps are detachably and adjustably joined around the bolster and the perimeter portion of the base pad.

### CROSS REFERENCE TO RELATED APPLICATIONS

This application claims the benefit of U.S. Provisional Application No. 60/681,297, filed May 16, 2005.

### FIELD OF INVENTION

This invention is directed to an improved dog beg and in particular to one having a cover with an internal strapping system which holds the cover to the shape of a fill material.

### BACKGROUND

Dog beds are well known and provide a comfortable and familiar place for dogs to rest. Overtime a dog bed in regular use will tend to absorb its canine occupant's odors, oils and body fluids, accumulate dust, dirt, become infested by ticks and fleas, and frequently be subjected to generally rough treatment. If a dog bed is used outdoors, it may become waterlogged or moldy, and will deteriorate in the elements. Because a dog bed becomes objectionable after a relatively short time, many dog owners will replace it two or more times per year.

Dog beds are typically manufactured of an inexpensive fill material surrounded by a fabric cover, since it is expected that a dog bed will be worn down in a relatively short period of time. The use of inexpensive and low-quality materials is therefore consistent with the planned obsolescence of the product.

A common annoyance with prior art dog beds is a function of the cover not being firmly attached to the fill material. The cover will eventually pull away from or out of any interior corners or recesses in the fill material requiring that it be tucked back in to retain a neat appearance. Eventually, if the cover pulls completely away from the fill material, the dog bed assumes an amorphous an unsightly appearance.

There is therefore a need for a dog bed that is resistant to odors, oils, dirt and insects, that will not deteriorate when subjected to the elements, and that is durable enough to withstand rough treatment. Ideally, the cover of an improved dog bed would continue to conform to the shape of the fill material even after long usage.

### SUMMARY OF THE INVENTION

An improved dog beg according to the invention comprises a malleable fill material composed of a base pad and bolsters generally including a back pad, and side pads. The back pad and bolsters collectively define an exterior shape. Preferably, the dog bed is rectangular and a middle portion of the base pad is surrounded on three sides by the back and side pads to the define a resting surface for the dog. An easy entry path to the resting area is thus provided on the remaining side. An inside face of the back and side pads extends upwardly from the resting surface to the top face of the pads. The inside face and the resting surface meet at a lower intersection forming three sides of the perimeter of the resting surface.

A cover envelops the fill material and conforms snugly to the exterior shape. Preferably, the cover is provided with a zipper or other fastener along its back side and along at least a part of each side of the bed to enable the cover to be opened sufficiently to remove the fill material.

A plurality of straps are attached to the inside of the cover; a lower length of each strap is attached to the cover at a lower attachment site coinciding with the lower intersection. The lower length of the strap passes downward through an aperture in the fill material from the lower intersection to the lower surface of the base pad; thence it extends outwardly along the bottom face to the outer side surface of the base pad, and therefrom upwardly. An upper length of the strap is attached to the cover at an upper attachment site coincident with an upper intersection formed where the top and outside faces of the back and side pads meet and extends downward therefrom along the outside face of the back or side pad. The strap lengths are detachably fastened together to keep the cover at the lower attachment sites tucked into the lower intersection around the perimeter of the resting surface and to hold the cover in place at the upper attachment sites adjacent the upper intersection. Preferably, at least two straps are provided along each side and back pad to supply at least a couple of retention points along each pad for controlling the cover.

The fill material is preferably a high density foam product. The cover according to the invention is a soft, but durable, marine quality vinyl fabric which can be hosed off, dries quickly, and is stain resistant. The combination of the durable vinyl cover over high density foam provides a rugged and comfortable bed for dogs. The strap system retains the cover in the configuration of the exterior shape of the foam which makes the bed easier to clean and move and gives it a tidy look.

### BRIEF DESCRIPTION OF THE DRAWINGS

FIG. 1 is a perspective view of an improved dog bed according to the invention.

FIG. 2 is a cutaway bottom view of the dog bed showing the base pad of the fill material and showing the straps for holding the cover to the fill material.

FIG. 3 is a sectional elevation view of the dog bed shown in FIG. 1 taken along line 3-3 of FIG. 1.

FIG. 4 is a sectional elevation view of the dog bed shown in FIG. 1 taken along line 4-4 of FIG. 1.

FIG. 5 is a rear elevation view of the dog bed shown in FIG. 1.

FIG. 6 is a perspective view of an alternate embodiment of an improved dog bed according to the invention.

### DETAILED DESCRIPTION OF THE ILLUSTRATED EMBODIMENT

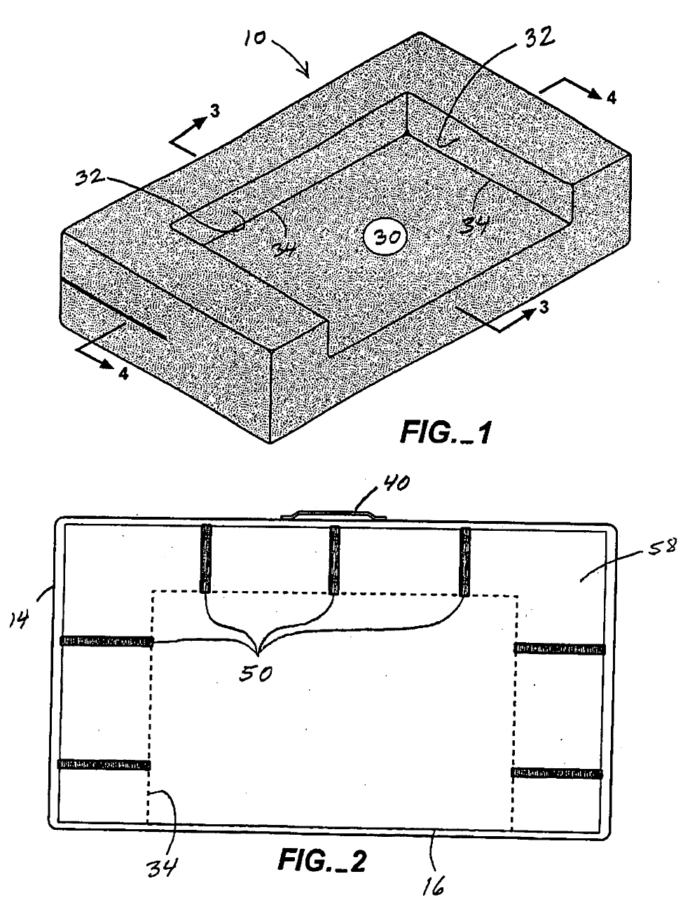

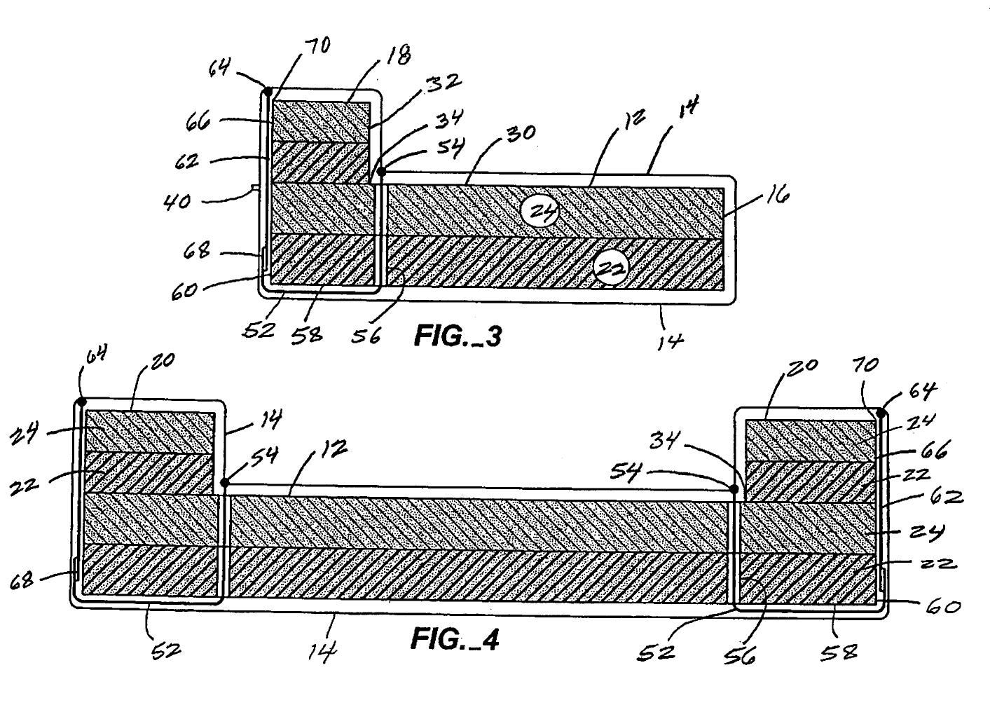

An improved dog bed according to the invention is illustrated in the accompanying drawings. With reference initially to the preferred embodiment shown in FIG. 1, an improved dog bed, generally indicated at 10, comprises a malleable fill material 12 and a cover 14. The fill material comprises a base pad 16, a back pad 18 and two side pads 20 abutting the back pad 18. In the preferred embodiment, the fill material is comprised of foam, but could alternatively be comprised of any malleable material that recovers its shape after being deformed. In the illustrated embodiment, each pad 16, 18, 20 is comprised of two layers, a bottom layer 22 and a top layer 24. See FIGS. 2 and 3. The bottom layer 22 is more dense and less malleable than the top layer 24. It provides a platform or foundation for the top layer 24. The combination of a stiffer bottom layer 22 and softer, more malleable top layer 24 permits construction of a dog bed which is better at holding its shape due to the bottom layer 22, yet comfortably malleable due to the top layer 24. The invention is not restricted to the pads being formed of two layers; pads in alternate embodiments being constructed of one or more than two layers.

The fill material forms a rectilinear external shape as best seen in FIG. 1. A primary advantage to such a shape is that the fill material can be cut during the manufacturing process from large blocks with very little manufacturing waste. It is, however, within the contemplation of the invention that a dog bed constructed of malleable foam could be constructed in a myriad of other shapes such as the oval configuration 26 shown in FIG. 6. In alternate embodiments, instead of using several pieces, the fill material may be fashioned of a single piece molded in a desired shape.

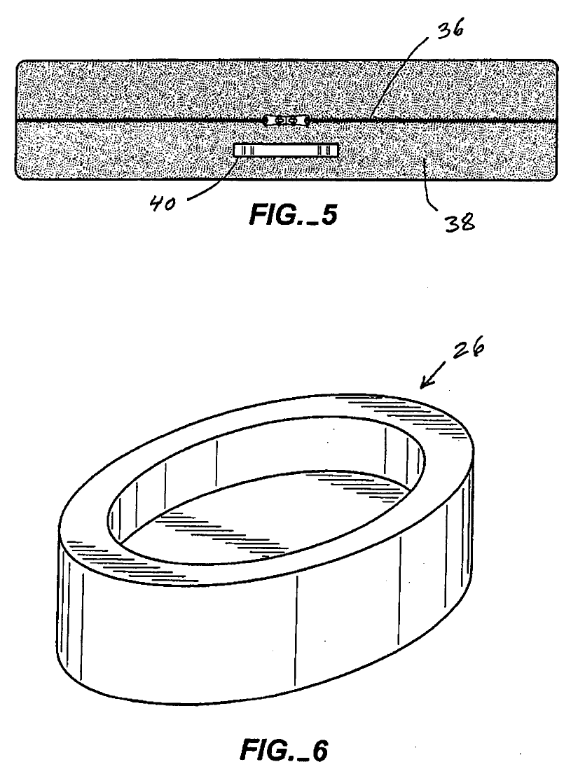

The back and side pads 18, 20 surround and define a resting surface 30 on the top layer 24 of the base pad 16. The resting surface meets the inside face 32 of the back and side pads 18, 20 at an intersection 34. The cover 14 envelops and hugs the shape of the fill material 12. A zipper 36 or other fastener is provided along the back side 38 of the dog bed as shown in FIG. 5. A handle 40, also attached to the back side of the bed, allows the dog bed to easily be carried.

A plurality of straps 50 are attached to the inside of the cover 14, a bottom length 52 of each strap secured to the cover at a lower attachment site 54 coinciding with the intersection 34. The bottom length 52 passes downward through an aperture 56 in the base pad 16 to the lower surface 58 of the base pad, thence extending along the lower surface 58 to the outer side surface 60 thereof. An upper length 62 of the strap is attached at an upper attachment site 64 and depends along the outside face 66 of the back and side pads 18, 20. The ends of the bottom and top lengths 52, 62 are detachably fastened at 68 along the outside face of the back and side pads 18, 20 or the outer side surface of the base pad 16, at a location easily accessible when the zipper 36 is opened. When the strap is fastened, the bottom length 52 retains the cover 14, via attachment site 54, neatly tucked to the intersection 34 of the base 16 and back or side pads 18, 20, and the upper length 62 holds the cover 12 against the outside top corner 70 of the back and side pads 18, 20 via upper attachment site 64 and pulls the cover snugly against the inside and top faces of the back and side pads. The strap system thus retains the cover in the configuration of the exterior shape of the foam which makes the bed easier to clean and move and gives it a tidy appearance. The cover is easily removed from the pads by opening the zipper 36 and detaching the strap lengths 52, 62.

The cover 14 is a preferably manufactured from a soft, but durable, marine quality vinyl fabric which can be hosed off, dries quickly, is stain resistant and does not deteriorate rapidly when exposed to the elements. In alternate embodiments the cover could be constructed of various polyethylene or polyurethane products.

There have thus been described certain preferred embodiments of an improved dog bed. While preferred embodiments have been described and disclosed, it will be recognized by those with skill in the art that modifications are within the true spirit and scope of the invention.

I claim:

1. A dog bed comprising:
a base pad having an upper surface, a lower surface, a plurality of outer side surfaces, a perimeter portion, and a plurality of apertures, each aperture extending from said upper surface to said lower surface,
at least one bolster disposed on said perimeter portion, said bolster having a top face, a bottom face, an inside face, an outside face, and a length, said outside face of said bolster generally in parallel alignment with one of said outer side surfaces of said base pad, said inside face of said bolster meeting said upper surface of said base pad at a lower intersection, said top and outside faces of said bolster meeting at an upper intersection,
a cover enveloping said base pad and said bolster,
a securing system for holding said cover snugly against said base pad and said bolster, said securing system having a plurality of straps, at least one strap disposed along said length of each bolster, each said strap comprising a lower strap and an upper strap, said lower strap attached to said cover at a lower attachment site adjacent said lower intersection, said lower strap extending from said lower attachment site through one of said apertures in said base pad, said upper strap attached to said cover at an upper attachment site adjacent said upper intersection, said upper attachment site generally in vertical planar alignment with said lower attachment site, said lower and upper straps detachably affixed around said bolster and said perimeter portion of said base pad.

2. The dog bed of claim 1 wherein:
said cover comprises marine-grade vinyl fabric.
